(19) United States
(12) Patent Application Publication
(10) Pub. No.: US 2012/0051812 A1
(43) Pub. Date: Mar. 1, 2012

(54) GLOSSING APPARATUS, IMAGE FORMING APPARATUS, POST-PROCESSING APPARATUS AND IMAGE FORMING SYSTEM

(75) Inventors: Miho YAMANO, Tokyo (JP); Hiroshi FUNABIKI, Uenohara-shi (JP)

(73) Assignee: KONICA MINOLTA BUSINESS TECHNOLOGIES, INC., Tokyo (JP)

(21) Appl. No.: 13/205,817

(22) Filed: Aug. 9, 2011

(30) Foreign Application Priority Data
Aug. 25, 2010 (JP) 2010-188000

(51) Int. Cl. G03G 15/20

(52) U.S. Cl. 399/341

(57) ABSTRACT

A glossing apparatus including: a first roller comprising a heating member; a second roller disposed downstream of the first roller with respect to the recording medium feeding direction; a belt member extended by the first roller and the second roller; and a third roller which presses the first roller via the belt member, wherein the recording medium is conveyed in such a manner that the image forming surface of the recording member is adhered to the belt member after the recording member is heated and pressed between the belt member and the first roller, wherein a plurality of through-holes is provided to the belt member, and a releasing agent is applied to inner surfaces of the through-holes.

This application is based on Japanese Patent Application No. 2010-188000 filed on Aug. 25, 2010 with the Japanese Patent Office, the entire content of which is hereby incorporated by reference.

### TECHNICAL FIELD

The present invention relates to a glossing apparatus, and a post-processing apparatus, image forming apparatus, and an image forming system, all of which include the glossing apparatus, and an image forming system.

### BACKGROUND OF THE INVENTION

Conventionally, as a glossing apparatus to provide glossy printed matter, an apparatus has been known, which utilizes an image receiving paper sheet (generally known as a glossy-print paper sheet) which is made by forming a toner receiving layer, or the like, of a resin layer having low permeability on the both side of a normal recording paper sheet, as disclosed by Unexamined Japanese Patent Application Publication No. 2007-52248 (hereinafter referred to as Patent Document 1). With this method, gloss is provided on the surface of the glossy-print paper sheet by embedding toner images into the toner receiving layer which has been softened by applying heat and pressure to the glossy-print paper sheet so as to reduce the unevenness of the surface of the glossy-print paper sheet. On the other hand, however, this method may produce a phenomenon of so-called “blister” in which, when a glossy-print paper sheet is heated, moisture and gas, contained in the glossy-print paper sheet, expand and burst through or swell the surface of the resin layer which has been softened by heat having been applied. In order to control this blistering, a technique is suggested in Patent Document 1, in which holes or grooves are formed in the resin layer of the glossy-print paper sheet.

However, even if the blister is controlled by forming holes or grooves within a recording paper sheet as described in Patent Document 1, problems in which the quality of a glossy image is deteriorated may still exist.

### SUMMARY OF THE INVENTION

The present invention has been achieved in consideration of the above problems, and to provide a glossing apparatus, a post-processing apparatus, an image forming apparatus, and an image forming system capable of providing a high quality glossy images for a long period of time without being influenced by blistering, not only for glossy recording paper sheets, but also for normal recording paper sheets (hereinafter, glossy recording paper sheets and normal recording paper sheets are collectively referred to as “recording medium”).

[1] To achieve at least one of the above-mentioned objects, a glossing apparatus reflecting one aspect of the present invention may include, but is not limited to: a first roller comprising a heating member; a second roller disposed downstream of the first roller with respect to the recording medium feeding direction; a belt member extended by the first roller and the second roller; and a third roller which presses the first roller via the belt member, wherein the recording medium is conveyed in such a manner that an image forming surface of the recording member is adhered to the belt member after the recording member is heated and pressed between the belt member and the first roller, wherein a plurality of through-holes is provided to the belt member and a releasing agent is applied to the inner surfaces of the through-holes.
[2] The glossing apparatus of [1], reflecting another aspect of the present invention, further includes a cooling member downstream of the first roller.
[3] The glossing apparatus of [1], reflecting still another aspect of the present invention, wherein the belt member is formed of either a metal or a resin.
[4] The glossing apparatus of [1], reflecting still another aspect of the present invention, wherein the belt member is an endless belt.
[5] The glossing apparatus of [1], reflecting still another aspect of the present invention, wherein the belt member is a long sheet-like continuous sheet which is wound onto a master roller and is rewound by a rewinding roller.
[6] The glossing apparatus of [1], reflecting still another aspect of the present invention, wherein a releasing agent is applied onto an area of the belt member, the area being opposite to the image forming surface of the recording medium.
[7] The glossing apparatus of [1], reflecting still another aspect of the present invention, wherein the plurality of through-holes of the belt member is provided in an area which corresponds to the image forming surface of the recording medium which is conveyed by the belt member.
[8] The glossing apparatus of [1], reflecting still another aspect of the present invention, wherein the plurality of through-holes of the belt member is provided so as to have a tapered shape having a larger diameter at the inner side of the belt member than the diameter of outer side of the belt member.

### BRIEF DESCRIPTION OF THE DRAWINGS

The preferred embodiments of the present invention are shown by way of example, and not limitation, in the accompanying figures, in which:

FIG. 1 is a diagram schematically showing a configuration of an image forming apparatus according to a first preferred embodiment of the present invention.

FIG. 2 is a diagram schematically showing a glossing apparatus according to the first preferred embodiment of the present invention.

FIGS. 3a-3c each is a diagram schematically showing a through-hole of a belt member according to a preferred embodiment of the present invention.

FIGS. 4a-4c each is a diagram schematically showing a model ofblistering occurrence in case of a belt having low permeability.

FIGS. 5a-5b each is a diagram schematically showing a model of blistering control in case of a belt member having through-holes according to a preferred embodiment of the present invention.

FIG. 6 is a diagram schematically showing a glossing apparatus according to a second preferred embodiment of the present invention.

FIG. 7 is a diagram schematically showing an image forming apparatus according to a third preferred embodiment of the present invention.

### DETAILED DESCRIPTION OF THE PREFERRED EMBODIMENTS

Hereafter, although preferred embodiments of the present invention will be described in detail, the present invention is not limited to these embodiments.

### First Embodiment

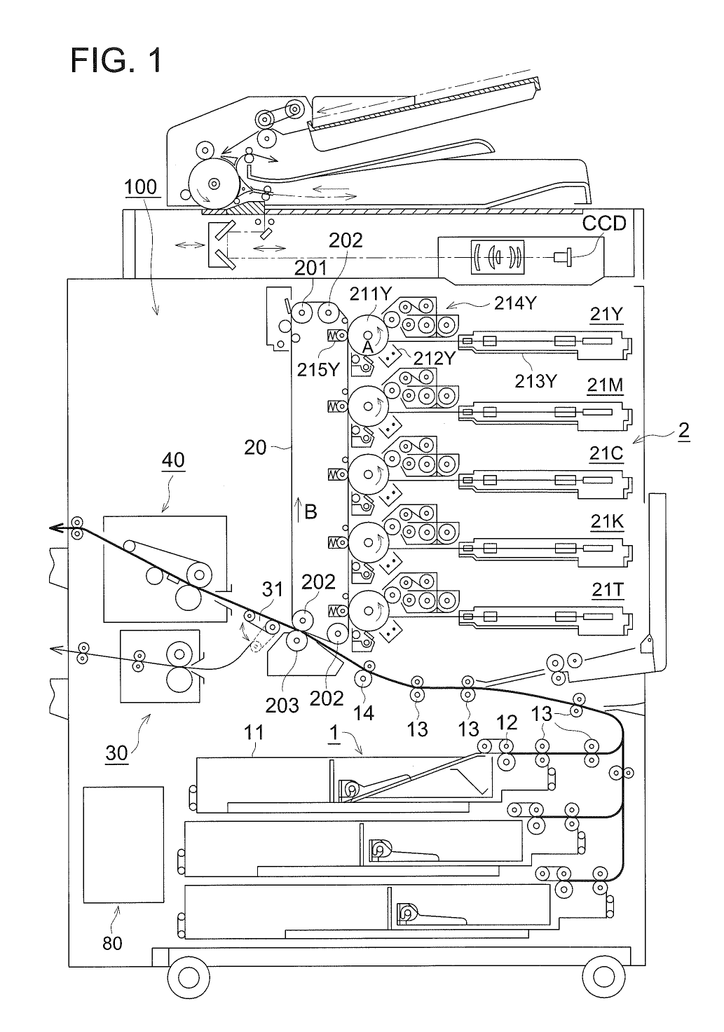

FIG. 1 is a diagram schematically showing a configuration of image forming apparatus 100 which is equipped with glossing apparatus 40 according to a first preferred embodiment of the present invention. Image forming apparatus 100 includes, at least, sheet feeding section 1, toner image forming section 2, and glossing apparatus 40.

Sheet feeding section 1 is composed of a plurality of trays 111, a plurality ofpickup rollers 12, a plurality of conveyance rollers 13, and registration roller 14. A number of sheets of a predetermined size of recording medium are stacked in each of trays 11, and the recording medium is fed by activating pickup roller 12 at one of trays 11 which is designated in accordance with instructions from control section 80. Note that trays 11 are used to stack not only normal recording paper sheets, but also glossy recording paper sheets. Conveyance rollers 13 convey the recording medium having been fed from tray 11 via pickup roller 12 to registration roller 14. Registration roller 14 adjusts the timing when the recording medium is provided to toner image forming section 2.

Toner forming section 2 represents a color image forming apparatus of a tandem image forming method employing an intermediate transfer body, and includes, but is not limited to, 5 process units of 21Y-21T, transfer belt 20, drive roller 201, tension rollers 202, and secondary transfer roller 203, which will all be described in detail later. At the peripheral edge part of transfer belt 20, which is an intermediate transfer body, 5 process units of 21Y-21T are provided, which include colored toner image forming sections of yellow toner Y, magenta toner M, cyan toner C, and black toner K, all of which are colored toner, and clear toner image forming section of clear toner T which is transparent. In other words, the colored toner image forming section of yellow toner Y corresponds to process unit 21Y, the colored toner image forming section of magenta toner M corresponds to process unit 21 M, the colored toner image fanning section of cyan toner C corresponds to process unit 21C, the colored toner image forming section of black toner K corresponds to process unit 21K, and the clear toner image forming section of clear toner T corresponds to process unit 21T. At each of process units 21Y-21T, each of a toner image of Y (yellow), M (magenta), C (cyan), and K (black), and T (transparent) is formed respectively, and then superposed and transferred onto transfer belt 20. The toner images, having been transferred, are transferred collectively onto a recording medium of which the timing has been adjusted by registration roller 14. Clear toner T is selected to be used to gloss over an image which is specifically required to be glossy, and is used for all areas of the recording medium having toner images formed by each color of toner Y, toner M, toner C, and toner K, or non-image area of the recording medium where no toner image is formed. By passing the recording medium with clear toner T through a glossing apparatus according to the preferred embodiments of the present invention, high-gloss image is obtained. Note that, in the preferred embodiments of the present invention, the state, in which at least one of toners of toner Y, toner M, toner C, toner K and clear toner T is placed on a recording medium, is called as toner image.

Because all of 5 process units of 21Y-21T include common components, process unit 21Y among the 5 units will only be described. Process unit 21Y includes, but is not limited to, photoconductive drum 211Y, charging unit 212Y, exposure unit 213Y, developing section 214Y, and primary transfer roller 215Y. Photoconductive drum 211Y is an image bearing member of which the surface a photoconductive layer is formed, and is driven to rotate in the direction of arrow A in the figure by a drive section, which is not illustrated in the figure. Charging unit 212Y applies an electric charge evenly to the surface of photoconductive drum 211 to charge the surface uniformly. Exposure unit 213Y is provided with an optical beam emitting source such as a laser diode, or the like, and irradiates light beams to the charged surface of photoconductive drum 211Y to neutralize electric charges of the illuminated portion so as to form an electrostatic latent image in accordance with image data of color of yellow.

Developing section 214Y contains yellow toner Y and forms the toner image of yellow from the electrostatic latent image, which corresponds to the image data of yellow, formed on the surface of photoconductive drum 211Y, by supplying yellow toner Y to photoconductive drum 211Y. The same process is applied to the other developing sections of magenta M, cyan C, and black K. Here, process unit 21 for clear toner T is controlled by control section 80 so as to form electrostatic latent image for clear toner T on the non-image area only when a glossy image is required to be obtained, or not to form electrostatic latent image for clear toner T when a glossy image is not required. Note that the same effect can be obtained by forming electrostatic latent image for clear toner T on all areas of the recording medium when a glossy image is required to be obtained. Primary transfer roller 215Y is placed opposite of photoconductive drum 211Y through the intermediary of transfer belt 20, and transfers toner images on photoconductive drum 211Y onto transfer belt 20. The same is applied to the other primary transfer rollers of magenta M, cyan C, black K, and clear T.

Transfer belt 20 is an endless belt, and is extended by drive roller 201 and a plurality of tension rollers 202. Transfer belt 20 is driven by a drive section, which is not illustrated in the figure, to rotate in the direction of arrow B, in the figure, and transfers the toner image, having been transferred from the photoconductive drums, onto a recording medium via secondary transfer roller 203, the recording medium having been fed from sheet feeding section 1. The recording medium, onto which the toner image has been transferred, is conveyed to glossing apparatus 40, and is ejected as a glossy image.

Note that, when a glossy-image is not required, conveyance path for the recording medium is changed to the conveyance path to fixing unit 30 via conveyance switching section 31 based on a selection of non-gloss at an operation section, which is not illustrated in the figure, the recording medium is fixed and ejected without passing through glossing apparatus 40.

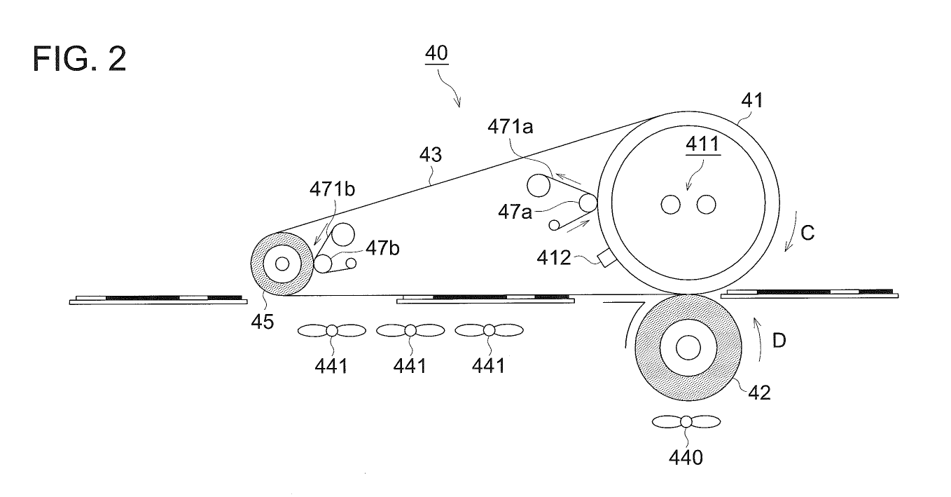

Here, glossing apparatus 40 will be now described with reference to FIG. 2. Glossing apparatus 40 includes, but is not limited to, first roller 41, second roller 45, third roller 42, belt member 43, cooling member 440, a plurality of cooling members 441, and cleaning rollers 46a and 47b. Belt member 43 is extended by first roller 41, second roller 45 which is disposed downstream of first roller 41 in the direction of conveyance of recording medium, and moves via the rotation of first roller 41.

First roller 41 has a releasing layer made of a fluorine resin tube of the thickness of approximate 30 μm around a cylindrical core that is made of metal with a high thermal conductivity, and is provided with heat source 411 which is equipped with a plurality of heaters as heating members such as halogen lamps, or the like, inside the cylindrical core. First roller 41 is driven to rotate in the direction of arrow C in the figure by a drive section, which is not illustrated in the figure, while being heated by heat source 411 so that the temperature of the surface becomes a predetermined temperature, and the temperature is controlled by temperature detecting sensor 412.

Third roller 42 is made of a cylindrical core having a high thermal conductivity, covered by an elastic body layer of a silicon rubber of rubber harness degree (RSA) of approximate 32°, or the like, and a similar releasing layer of that of first roller 41 is formed on the surface of the elastic body layer. Third roller 42 is driven to rotate in the direction of D in the figure by a drive section, which is not illustrated in the figure. Also, third roller 42 is pressed into contact with first roller 41, and ensures a nip width of at least 10 mm by the elastic body layer of a silicone rubber, or the like.

When a recording medium, onto which a toner image has been transferred, passes through the nip between first roller 41 and third roller 42, the toner image on the recording medium is softened by heat and pressure, and fixed onto the recording medium in the state in which the toner image adheres tightly to the surface of belt member 43.

A plurality of cooling members 441 is disposed at the recording medium side of belt member 43 between first roller 41 and second roller 45 which is disposed downstream of first roller 41, and help dissipate the heat of belt member 43 and the recording medium in the state of a tight adherence, and cool belt member 43 and the recording medium. Also, since third roller 42 has a high heat capacity constitutionally and because blistering occurs when the temperature of third roller exceeds a specified temperature, third roller 42 is cooled down by cooling member 440 such as a fan, a compressor, or the like.

The recording medium, of which the toner image, in the state of a tight adherence to belt member 43, has been fixed, is conveyed by the movement of belt member 43 while being cooled by cooling members 441. In the meantime, the toner image on the recording medium becomes solidified along with the surface of belt member 43, which has a high smoothness, and the recording medium is ejected. Thus, a glossy surface of a smooth toner surface can be obtained. It is preferable to dispose cooling members 441, which have necessary capacity to make the temperature of the belt approximately 50° C. just before second roller 45, for example.

The cooling distance of belt member 43, in other words, the distance between first roller 41 and second roller 45, where the image forming surface of the recording medium adheres tightly to belt member 43, is approximately 500 mm, as an example.

Second roller 45 is driven to rotate by the movement of belt member 43 by extending belt member 43 together with first roller 41. Via second roller 45, the recording medium is separated from belt member 43 by the stiffness of the recording medium itself and the curvature of belt member 43. Second roller 45 is composed of a metallic roller, such as aluminum as an example, of a diameter of approximately 20 mm covered by a rubber layer of a thickness of approximately 5 mm. On the surface of second roller 45, a similar releasing layer, which is made of a fluorine resin tube, or the like, of which first roller 41 and third roller 42, is formed.

Cleaning rollers 47a and 47b press cleaning sheets 471a and 471b into contact with first roller 41 and second roller 45 respectively to remove a toner, a foreign substance such as paper dust from a recording medium, or the like, which have solidified inside the through-holes of belt member 43 and moved to the surfaces of first roller 41 and second roller 45. The through-holes of belt member 43 will be described in detail later. These cleaning rollers 47a and 47b clean the surfaces of first roller 41 and second roller 45 via sheets 471a and 471b by moving cleaning sheets 471a and 471b in accordance with the rotation of cleaning rollers 47a and 47b.

Now, belt member 43, according to the first preferred embodiment of the present invention, will be described. As a material of belt member 43, an endless belt, which is made of polyimide (PI) material of a thickness of 60 μm, of a width of 500 mm and a belt diameter of 500 mm is used. Through-holes having an aperture diameter of 50 μm at the inner surface of the belt member and an aperture diameter of 40 μm at the outer surface which contacts a recording medium, are formed with a density of 2 holes per cm², via laser processing.

To belt member 43, on which a plurality of through-holes has been formed, a releasing agent of a thickness of 5 μm is applied to the inside of the through-holes, and to the surface which contacts a recording medium or both surface ofbelt member 43. Via such releasing layer, having been formed by the applied releasing agent, high smoothness is obtained on the surface, of belt member 43, which contacts a recording medium, and therefore, a toner which entered into a plurality of through-holes and solidified, and a foreign substance such as paper dust from a recording medium, or the like, which entered into a plurality of through-holes, are ejected without being clogged. Note that it is preferred that the above mentioned plurality of through-holes be provided in the area of the main scanning direction of the largest size of recording medium which can be used in the image forming apparatus. With this arrangement, areas where no through-hole is formed are provided at both end portions of belt member 43, so that the durability of belt member 43 is improved.

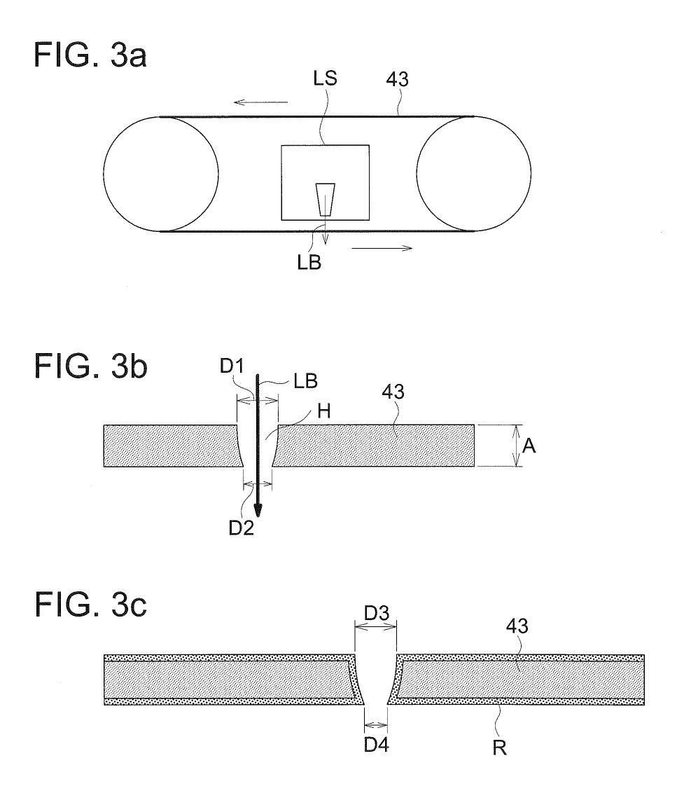

The through-holes of belt member 43 are now described in detail with reference to FIGS. 3a, 3b, and 3c, which are each a diagram schematically showing a procedure of creating through-hole through belt member 43 to form through-hole H, and applying a releasing agent to form releasing layer R.

As shown in FIG. 3a, a plurality of through-holes is formed by irradiating laser beam LB via laser apparatus LS while moving belt member 43 by a unit distance.

FIG. 3b is a magnified figure of through-hole H, having a tapered shape having diameter D1 of 50 μm of a side of the through-hole facing the laser and diameter D2 of 40 μm of a side of the through-hole opposite to the laser, through-hole H which is formed by irradiating laser beam LB via laser apparatus LS onto belt member 43, which is made of polyimide (PI) material of thickness A of 60 μm. To obtain through-holes H having such tapered shape, the amount of energy of laser beam LB, corresponding to the thickness of belt member 43, is adjusted, as an example. With this arrangement in which through-holes H are formed so as to have a tapered shape having a larger diameter at the inner side of the belt, even if a toner, a foreign substance such as paper dust from a recording medium, or the like, enters into through-holes H, the toner and foreign substance are more likely to be ejected due to the tapered shape.

Through-holes H are formed with a density of 2 holes per cm². A laser machining process is a process involving gasifying a material or dividing the material into micro-particles by causing the material to instantaneously (approximately 16 nanoseconds) absorb energy greater than its intermolecular force and breaking its intermolecular bonds. As a consequence, machining with minimized thermal effect can be achieved.

FIG. 3c shows a state in which releasing layer R of a thickness of 5 μm is formed uniformly on both surfaces of belt member 43 and the inner surface of through-hole H by applying a releasing agent by dipping and squeezing methods. After the releasing layer is formed, 50 μm of diameter D1 is changed to 40 μm of diameter D3, and 40 μm of diameter D2 is changed to 30 μm of diameter D4.

There are a variety of coating methods of a releasing agent depending on the viscosity of the releasing agent and the coating thickness after coating. In cases in which a releasing agent is not necessary on the inner surface of belt member 43, it is preferable to use a barcoater of rod No. 3 (rod diameter of 76 μm). Also, although a mold-release coating agent of non-silicone series is used in the case of FIG. 3c, a releasing agent of silicone series may also be used.

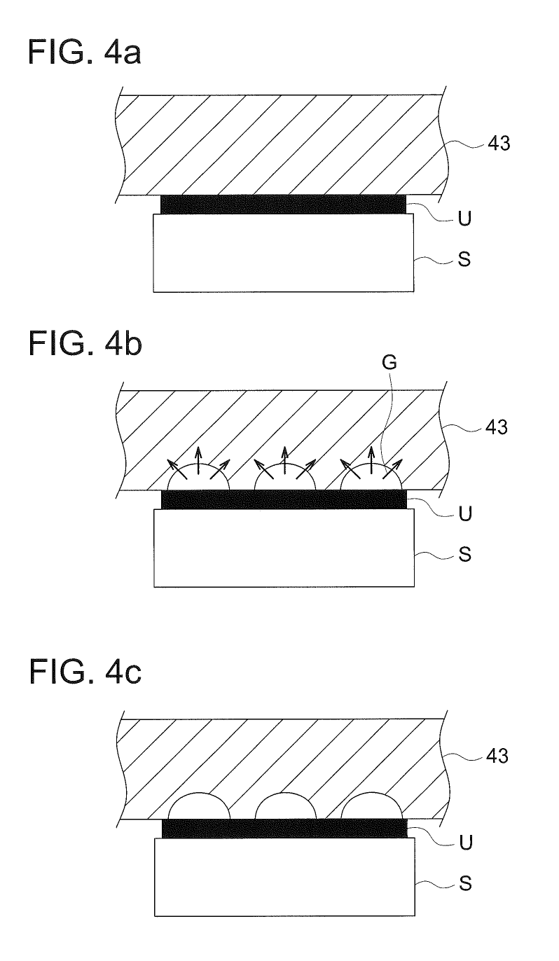

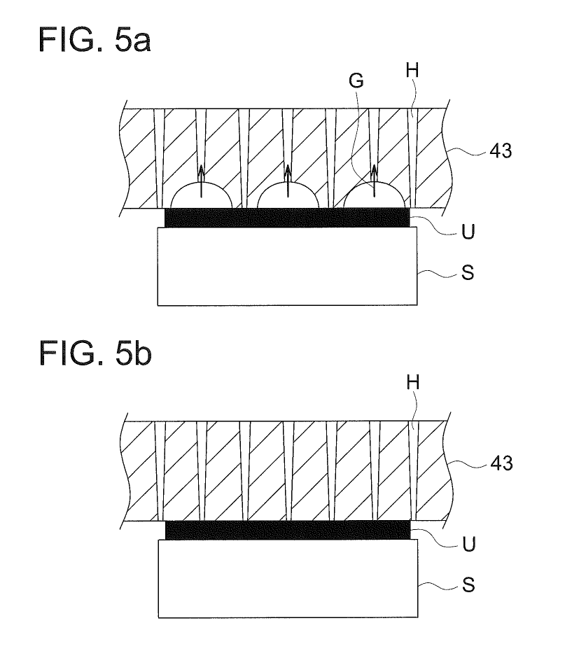

Here, an advantage of suppressing blistering by using a belt, which is made of a material of a metal or a heat resistant resin through which a plurality of through-holes has been formed, as belt member 43, or using a belt which is made of a porous material as belt member 43, is described with reference to FIGS. 4a-4c, and FIGS. 5a-5b.

First, to be explained will be how a blister is generated, in a case in which a belt having no permeability is used as belt member 43, with reference to FIGS. 4a-4c. As shown in FIG. 4a, toner image U having been formed on recording medium S is heated while the image forming surface of recording medium S is adhered to belt member 43. At this time, as shown in FIG. 4b, gaseous body G, such as moisture vapor or the like, generated from inside recording medium S, remains on recording medium S if belt member 43 has low permeability, and the generated gaseous body G pushes up belt member 43. On this occasion, belt member 43 is separated from the surface of the toner image, and belt member 43 and the surface of the toner image separated as shown in FIG. 4c, resulting in image roughness, or the like. This kind of problem likely occurs when the density of through-holes H is less than or equal to 1 hole per cm².

On the other hand, an advantage of suppressing blistering by using a belt, which is made of a material of a metal or a heat resistant resin through which a plurality of through-holes has been formed, as belt member 43, or using a belt which is made of a porous material as belt member 43, is described with reference to FIGS. 5a-5b. As shown in FIG. 5a, gaseous body G, such as moisture vapor or the like, generated from recording medium S, is ejected through the plurality of through-holes H formed in belt member 43.

In other words, even if toner image U, having been formed on recording medium S, is heated while the image forming surface of recording medium S is adhered to belt member 43, gaseous body G, such as moisture vapor or the like, generated from inside recording medium S, does not remain between recording medium S and belt member 43. Therefore, as shown in FIG. 5b, recording medium S and belt member 43 remain as being tightly adhered, and a high quality glossy image, having the smooth surface of belt member 43, can be obtained.

In order to maintain such state, the density of through-holes H of at least 2 holes per cm² is necessary. However, in cases in which the density of through-holes H is higher than 4 holes per cm², smoothness of the surface of belt member 43 is deteriorated in accordance with increased density of through-holes H, resulting in loss of glossiness. Thus, this is not suited to high quality glossy image.

With the above-mentioned construction, image forming apparatus 100 forms a toner image based on input image data. More specifically, image forming apparatus 100 transfers a toner image, having been formed via toner image forming section 2, onto a recording medium provided from sheet feed section 1. Then, the recording medium, onto which the toner image has been transferred, is conveyed to glossing apparatus 40.

In glossing apparatus 40, first roller 41 and second roller 42 melt the toner image on the recording medium while heating the recording medium, and convey the recording medium while pressing the recording medium into contact with belt member 43. At this time, because the melted toner image, on the surface of the recording medium, is conveyed while being adhered to the smooth surface of belt member 43, and is cooled and solidified via cooling members 441 by the time when the toner image reaches second roller 45, the toner image on the recording medium is ejected as a glossy image, the surface of which is very smooth.

In image forming apparatus 100 according to the preferred embodiment of the present invention, paths through which a gaseous body, such as a moisture vapor or the like, which is a cause of blistering, is exhaled, are formed by a plurality of through-holes having been formed in belt member 43. Via a plurality of through-holes, a gaseous body, such as a moisture vapor or the like, from a recording medium is exhaled successfully, generation of blistering can be controlled even if the temperature of the recording medium becomes high. Therefore, according to image forming apparatus 100 according to the preferred embodiment, an image of high gloss can be obtained by heating a recording medium without an occurrence of blistering.

Also, a mold-releasing agent is applied to the inner surface of the through-holes so that a melted toner, a foreign substance such as paper dust from a recording medium, or the like, does not clog a plurality of the through-holes having been formed in belt member 43 so as not to block the paths through which a gaseous body, such as a moisture vapor or the like, is exhaled. Furthermore, the toners and foreign substances such as paper dust from a recording medium, or the like, which have been emitted from the recording medium side of belt member 43 through the inner surface of through-holes, and solidified at the inner surface of belt member 43 and then moved to first roller 41 and third roller 45, are removed via cleaning sheets 471a and 471b which are pressed into contact with first roller 41 and third roller 45 by cleaning roller 47a and 47b.

By these proper responses, belt member 43 is capable of providing a high quality glossy image for a certain period of time without the effect of blistering.

### Second Embodiment

Next, glossing apparatus 40 according to a second preferred embodiment of the present invention will be described. An image forming apparatus, including glossing apparatus 40 according to the second preferred embodiment, has substantially the same construction as the above-mentioned image forming apparatus 100 according to the first preferred embodiment, and the only difference is the construction of glossing apparatus 40. Therefore, the difference only will be described in this second preferred embodiment.

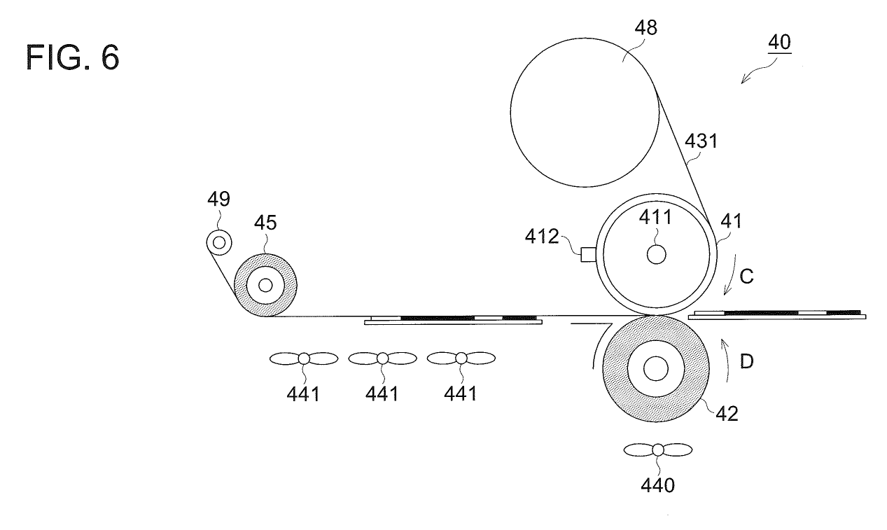

FIG. 6 is a diagram schematically showing glossing apparatus 40 according to the second preferred embodiment of the present invention. Glossing apparatus 40, shown in FIG. 6, utilizes a long sheet-like continuous belt of polyimide (PI) which is wound onto master roller 48 and is rewound by roll-up roller 49, instead of utilizing belt member 43 shown in FIG. 2.

As shown in FIG. 6, PI sheet 431, in which a plurality of through-holes has been formed and a mold-releasing agent has been applied to the inner side of the through-holes and to both sides of the sheet, or the side which is adhered to a recording medium, is wound by master roller 48. This PI sheet 431 is extended by first roller 41 and second roller 45, and moves by being driven via first roller 41, and provides a glossy appearance while being adhered to a recording medium, and then is rewound by roll-up roller 49. In cases in which the above-mentioned PI sheet 431 is utilized, in addition to the advantage of prevention of blistering, a cleaning mechanism becomes unnecessary, resulting in the improvement of reliability, the improvement of space utilization efficiency, and the reduction of cost. Furthermore, when compared to belt member 43 which is an endless belt, because no special consideration concerning the durability is required for PI sheet 431, a thinner PI sheet 431 can be used than that ofbelt member 43 which is an endless belt, and therefore, heat which is necessary for fixing of the recording medium can be transferred more efficiently, and a higher quality glossy image can be provided. By using a thinner PI sheet, the cooling distance for the melted toners can be shortened, and the spaces necessary for the master roller and the roll-up roller are decreased in size, resulting in downsizing and cost reduction of the glossing apparatus.

### Third Embodiment

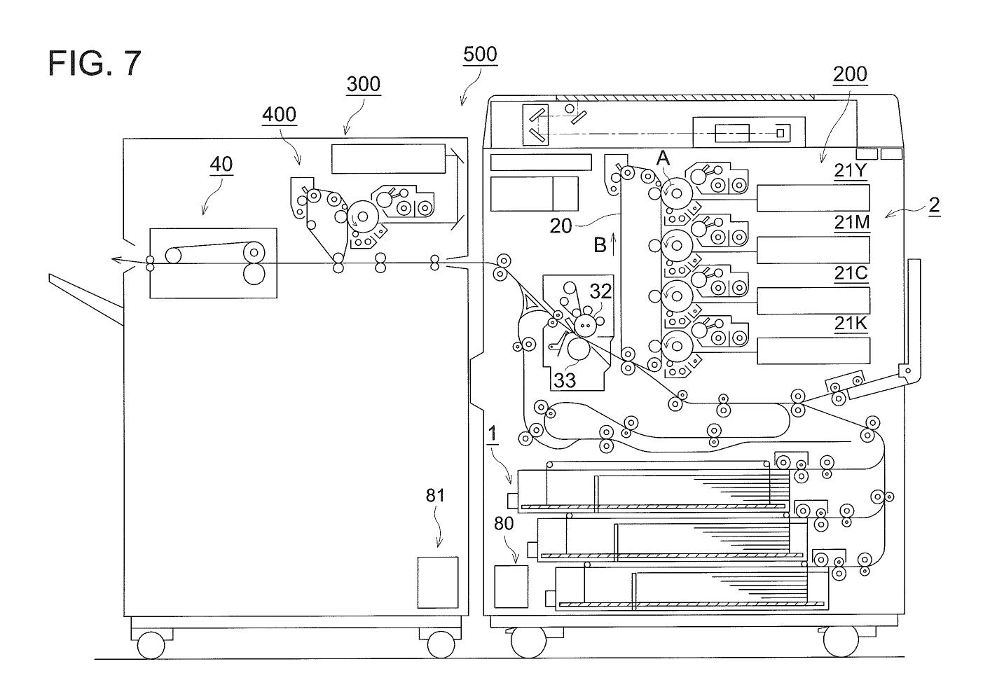

Glossing apparatus 40 according to a third preferred embodiment of the present invention will now be described. FIG. 7 shows image forming system 500 which includes, but is not limited to, image forming apparatus 200 which is provided with a fixing section which fixes a toner image formed on a recording medium by heat roller 32 and pressure roller 33, clear toner T providing apparatus 400, and glossing apparatus 40. Image forming apparatus 200 includes at least sheet feeding section 1, toner image forming section 2, and a fixing section. The roles and functional capabilities of the sheet feeding section 1, according to the third preferred embodiment, is the same as those of sheet feeding section 1 according to the first preferred embodiment. The roles and functional capabilities of toner image forming section 2, according to the third preferred embodiment, is the same as those of toner image forming section 2 according to the first preferred embodiment, except that toner image forming section 2 according to the third preferred embodiment does not include process unit 21T which is the clear toner image forming section of clear toner T. In toner image forming section 2, each toner image of each color of Y, M, C, and K is formed respectively by process units 21Y-21K described in the first preferred embodiment, and then superposed and transferred onto transfer belt 20. The toner images, having been transferred, are transferred collectively onto a recording medium of which the timing has been adjusted by sheet feeding section 1. The toner images, which have been transferred onto the recording medium, are fixed onto the recording medium in the fixing section.

By connecting glossing apparatus 40, of a belt member type having been explained in the first preferred embodiment of the present invention, as post-processing apparatus 300 to a connecting section provided at the sheet ejection port of image forming apparatus 200 so as to pass the recording medium, onto which the toner images have been fixed at the fixing section, through glossing apparatus 40, a high quality gloss providing functional capability can be added to a conventional image forming apparatus. Furthermore, by providing clear toner T providing apparatus 400, which is similar to process unit 21T which provides clear toner T only to a recording medium, in post-processing apparatus 300, a higher quality gloss can be provided.

In any of those cases, by having a coordination ofprogram between post-processing apparatus 300 and control section 81, and image forming apparatus 200 and control section 80, it is possible to select functions such as glossing at an entire area, glossing at non-image areas only, no-glossing, or the like. Also, via the above-mentioned coordination ofprogram, it is possible to set a condition for optimum glossiness, or the like, based on the thickness of the recording medium.

Meanwhile, an explanation has been given by the use of an example wherein glossing apparatus 40 according to the first preferred embodiment is applied to post-processing apparatus 300. However, the scope of the invention is not limited to the example, and glossing apparatus 40 according to the second preferred embodiment may of course be applied.

Although the preferred embodiment of the present invention have been fully described by way of examples with reference to the accompanying drawings, it is to be noted that various changes and modifications will be apparent to those skilled in the art. Therefore, unless such changes and modifications depart from the scope of the present invention, they are to be construed as being included therein.

What is claimed is:

1. A glossing apparatus comprising:
a first roller comprising a heating member;
a second roller disposed downstream of said first roller with respect to a recording medium feeding direction;
a belt member extended by said first roller and said second roller; and
a third roller which presses said first roller via said belt member,
wherein said recording medium is conveyed in such a manner that an image forming surface of said recording member is adhered to said belt member after said recording member is heated and pressed between said belt member and said first roller,
wherein a plurality of through-holes is provided to said belt member and a releasing agent is applied to inner surfaces of said through-holes.

2. The glossing apparatus of claim 1, further comprising a cooling member downstream of said first roller.

3. The glossing apparatus of claim 1, wherein said belt member is formed of either a metal or a resin.

4. The glossing apparatus of claim 1, wherein said belt member is an endless belt.

5. The glossing apparatus of claim 1, wherein said belt member is a long sheet-like continuous sheet which is wound onto a master roller and is rewound by a roll-up roller.

6. The glossing apparatus of claim 1, wherein a releasing agent is applied onto an area of said belt member, the area being opposite to said image forming surface of said recording medium.

7. The glossing apparatus of claim 1, wherein said plurality of through-holes of said belt member is provided in an area which corresponds to said image forming surface of said recording medium, said recording medium being conveyed by said belt member.

8. The glossing apparatus of claim 1, wherein said plurality of through-holes of said belt member is provided so as to have a tapered shape, having a larger diameter at the inner side of said belt member than the diameter of outer side of said belt member.

9. An image forming apparatus comprising:
a toner image forming section which forms an image on a recording medium; and
the glossing apparatus of claim 1.

10. The image forming apparatus of claim 9, further comprising:
a colored toner image forming section which forms a toner image with a colored toner; and
a clear toner image forming section which forms a toner image with a clear toner.

11. A post-processing apparatus comprising:
a connection section to an image forming apparatus which forms an image on a recording medium; and
the glossing apparatus of claim 1.

12. The post-processing apparatus of claim 11, further comprising a toner image forming section which forms a toner image with a clear toner.

13. An image forming system comprising:
an image forming apparatus which forms an image on a recording medium; and
processing apparatus of claim 11.
